(19) United States
(12) Patent Application Publication
(10) Pub. No.: US 2024/0303768 A1
(43) Pub. Date: Sep. 12, 2024

(54) Multidimensional Image Scaler

(71) Applicant: Apple Inc., Cupertino, CA (US)

(72) Inventors: Yang Li, San Jose, CA (US); ByoungSuk Kim, Palo Alto, CA (US); Fu-Chung Huang, Cupertino, CA (US); Jun Qi, San Jose, CA (US); Sheng Zhang, San Jose, CA (US); Victor H. Yin, Cupertino, CA (US); Wei H. Yao, Saratoga, CA (US); Yi Huang, San Jose, CA (US); Yi-Pai Huang, Zhubei (TW); Ping-Yen Chou, Santa Clara, CA (US)

(21) Appl. No.: 18/590,893

(22) Filed: Feb. 28, 2024

Related U.S. Application Data
(60) Provisional application No. 63/450,378, filed on Mar. 6, 2023.

(51) Int. Cl. G06T 3/40; G06T 15/00; G06V 20/70

(52) U.S. Cl. CPC G06T 3/40; G06T 15/00; G06V 20/70

(57) ABSTRACT

An electronic device uses a multidimensional (e.g., 3D) scaler to process multiple-viewing-angle (e.g., 3D-aware) images by resampling each view image and processing image data of each view image according to a view map to change resolution or improve perceived image quality. After being processed, each view image of the multiple-viewing-angle image is used to rebuild a final processed multiple-viewing-angle (e.g., 3D-aware image) with all views for displaying on the electronic device.

### CROSS-REFERENCE TO RELATED APPLICATIONS

This application claims priority to U.S. Application No. 63/450,378, filed Mar. 6, 2023, entitled “Multidimensional Image Scaler,” which is incorporated by reference herein in its entirety for all purposes.

### SUMMARY

This disclosure relates generally to image processing and, more particularly, to the scaling of and/or enhancement of image data used to display multidimensional (e.g., three-dimensional (3D)-aware) images on an electronic display.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Numerous electronic devices—including televisions, portable phones, computers, wearable devices, vehicle dashboards, virtual-reality glasses, and more—display images on an electronic display. To display an image, an electronic display may control light emission of its display pixels based at least in part on corresponding image data. Many electronic displays display two-dimensional images that present the same image regardless of viewing angle. Two-dimensional images may be upscaled or downscaled in a straightforward way by resampling nearby pixels.

Some electronic displays, however, may display multidimensional images that appear as different images when seen from different viewing angles. The various images that are seen from different angles may be described as different “views,” and these multidimensional images may be described as multiple-viewing-angle images. Several effects are possible with such an electronic display. For example, a multidimensional image may be divided into multiple views (e.g., multiple views of a three-dimensional object) to enable a stereoscopic effect when the viewer sees different images at each eye. In this way, the viewer may see a three-dimensional image and images of this type may be referred to as 3D-aware images. Yet upscaling or downscaling these images by merely resampling pixels of a multidimensional image could result in the different images becoming mixed, thereby defeating the stereoscopic three-dimensional effect.

To scale multidimensional images while preserving the multidimensionality of these images, this disclosure provides image scaling systems and methods to resample pixels view by view. In this way, individual pixels of a scaled multidimensional image may be generated by resampling other pixels of the original multidimensional image that are part of the same view. This may be done for upscaling or for downscaling. This form of scaling preserves the multidimensionality of multidimensional images and may be referred to as “dimensionality-aware image scaling” or, in the particular case of three-dimensional images, “3D-aware image scaling.”

Dimensionality-aware image scaling may improve the efficiency of multidimensional electronic displays. Generating high-resolution multidimensional images may involve substantial image processing and bandwidth. To mitigate this, processing circuitry may generate multidimensional images that have a lower resolution than a native resolution of an electronic display. The electronic display may receive the lower-resolution images and may scale the lower-resolution multidimensional image data into higher-resolution multidimensional image data of the native resolution of the electronic display. Similarly, higher-resolution image data may be downscaled to match a lower native resolution of an electronic display. After being processed, each view image of the multidimensional image may be used to rebuild a final processed multidimensional image with all views for displaying on the electronic device. Various image enhancements may also be used in the image processing for a view image of a multidimensional image, such as obtaining noise statistics, differential statistics, filtering, and the like. Depending on implementation, each view image of a 3D-aware image may be processed using same image enhancements or using respective image enhancements to improve a total perceived image quality of the 3D-aware image while reducing the likelihood of image artifacts and saving power.

### BRIEF DESCRIPTION OF THE DRAWINGS

Various aspects of this disclosure may be better understood upon reading the following detailed description and upon reference to the drawings described below.

FIG. 1 is a schematic block diagram of an electronic device, in accordance with an embodiment;

FIG. 2 is a front view of a mobile phone representing an example of the electronic device of FIG. 1, in accordance with an embodiment;

FIG. 3 is a front view of a tablet device representing an example of the electronic device of FIG. 1, in accordance with an embodiment;

FIG. 4 is a front view of a notebook computer representing an example of the electronic device of FIG. 1, in accordance with an embodiment;

FIG. 5 are front and side views of a watch representing an example of the electronic device of FIG. 1, in accordance with an embodiment;

FIG. 6 is an example of the electronic device in the form of a desktop computer, in accordance with an embodiment;

FIG. 7 is a schematic diagram illustrating a portion of a cross section of a multidimensional electronic display, in accordance with an embodiment;

FIG. 8 is a block diagram showing an embodiment of data flow, in accordance with an embodiment;

FIG. 9 is a block diagram showing a second embodiment of data flow, in accordance with an embodiment;

FIG. 10 is a block diagram showing a third embodiment of data flow, in accordance with an embodiment;

FIG. 11 is a block diagram showing a fourth embodiment of data flow, in accordance with an embodiment;

FIG. 12 is a block diagram illustrating image data scaling from low resolution to high resolution, in accordance with an embodiment;

FIG. 13 is a block diagram illustrating image data scaling from high resolution to low resolution, in accordance with an embodiment;

FIG. 14 is a block diagram illustrating image data converting, in accordance with an embodiment;

FIG. 15 depicts a flow diagram of a process for content dependent sampling, in accordance with an embodiment; and

FIG. 16 depicts a flow diagram of a process for temporal sampling, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B. In addition, as used herein, the terms “continuous”, “continuously”, or “continually” are intended to describe operations that are performed or objects that are distributed without any significant human-perceivable interruption. For example, viewing angles may be distributed in 3D space without any human-perceivable interruptions.

Multidimensional electronic displays present multidimensional images that appear as different images when seen from different viewing angles. The various images that are seen from different angles may be described as different “views.” Thus, as used herein, a multidimensional image may be any image that represents multiple different images when seen from multiple viewing angles. These different images may be referred to as “view images.” As such, a multidimensional image may also be referred to as a multiple-viewing-angle image. One particular example is known as a 3D-aware image, in which different viewing angles of the image represent different views of a three-dimensional object. Other examples of multidimensional images may include images that are seen as completely different objects from different angles (e.g., as viewed by different people). Views may be seen as continuous as the viewing angles may be continuously distributed in 3D space. For example, multidimensional displays may show various camera viewpoints or object poses of a three-dimensional (3D) object. For this reason, multidimensional electronic displays may also be referred to as “3D electronic displays” when they are used to display 3D-aware images.

To display an image, an electronic display controls light emission of its display pixels based on corresponding image data. The image data may represent a stream of pixel data corresponding to a target luminance of respective display pixels of the electronic display. Thus, the image data may indicate luminance per color component. For an RGB display, the image data may include red component image data for each red display pixel, blue component image data for each blue display pixel, and green component image data for each green display pixel.

The image data may be processed before being output to an electronic display or stored in memory for later use. Image processing circuitry such as a graphics processing unit and/or display pipeline may prepare the image data for display on the electronic display. Additionally or alternatively, such image processing may take place in software (e.g., execution of instructions stored in tangible, non-transitory, media), or in a processing unit of the electronic device.

It may be desirable to scale image data to a different resolution. This may allow the image data to match the resolution of an electronic display or to make part of the image appear larger. For images displayed on a multidimensional electronic display, image data may include pixel data having multiple view images (e.g., 3D pixel-directionality). As will be discussed further below, a view map may be used to define the view images (e.g., 3D pixel-directionality). An image including multiple views with 3D pixel-directionality information may be referred to as a 3D-aware image. Each 3D-aware image may have a corresponding view map (e.g., based on the particular capability of the electronic display) indicating pixel-directionality information.

This disclosure provides systems and methods for scaling the image data of a multidimensional image, such as a 3D-aware image, to change resolution while maintaining the fidelity of the different view images represented in the different views. Image processing of a multidimensional image may involve resampling different view images of a multidimensional image and processing image data of each view image of the multidimensional image to improve perceived image quality. Views may be continuous as the viewing angles may be continuously distributing in the 3D space, and the view map may be used to define the views (e.g., number of views, viewing angles included in a view). After being processed, each view image of the multidimensional image may be used to rebuild a final processed multidimensional image with all views for displaying on the electronic device.

In some embodiments, a processing pipeline may include a multidimensional scaler block (e.g., a 3D scaler block) to scale image data of multidimensional images (e.g., 3D-aware images). This image scaling may allow the image data to be scaled to a lower or higher resolution without, or with a reduced amount of, artifacts. The ability to increase the resolution of 3D-aware images without introducing noticeable artifacts may allow images to be stored at a lower resolution, thus saving memory space, power, and/or bandwidth, and restore the image to a higher resolution before displaying the image. Additionally, the image data may undergo further enhancement before being output or stored. As such, the 3D scaler block may incorporate hardware and/or software components to facilitate scaling of image data to a lower or higher resolution while reducing the likelihood of image artifacts, and/or undergoing image enhancement. Although this disclosure refers to a 3D scaler block in the context of a 3D-aware image, the 3D scaler block may be used for any suitable multiple-viewing-angle images, including those that are not 3D-aware images. Thus, where the disclosure refers to operations involving 3D-aware images, it should be understood to also encompass similar operations involving any other suitable multiple-viewing-angle images.

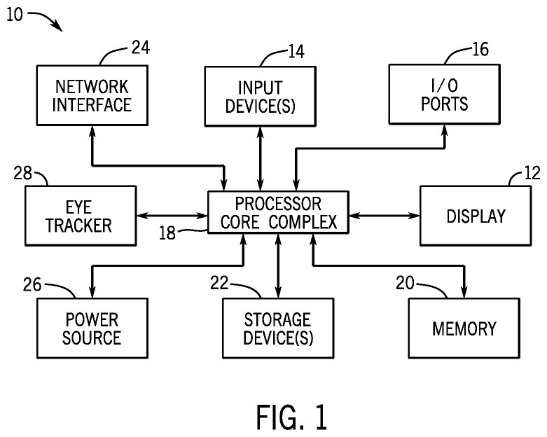

With this in mind, an electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processor(s) or processor cores, local memory 20, a main memory storage device 22, a network interface 24, a power source 26, and eye tracker 28. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable gate arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, a touch sensing, or the like. The input device 14 may include touch-sensing components (e.g., touch control circuitry, touch sensing circuitry) in the electronic display 12. The touch sensing components may receive user inputs by detecting occurrence or position of an object touching the surface of the electronic display 12.

In addition to enabling user inputs, the electronic display 12 may have a display panel with an array of display pixels that may display different view images from different viewing angles. For example, the electronic display 12 may include a self-emissive pixel array having an array of self-emissive display pixels and a lenticular lens layer. The electronic display 12 may include any suitable circuitry (e.g., display driver circuitry) to drive the self-emissive pixels, including for example row driver and/or column drivers (e.g., display drivers). Each of the self-emissive pixels may include any suitable light emitting element, such as an LED (e.g., micro-LED or OLED). However, any other suitable type of pixel, including non-self-emissive pixels (e.g., liquid crystal as used in liquid crystal displays (LCDs), digital micromirror devices (DMD) used in DMD displays) may also be used. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW arrangement).

The electronic display 12 may display an image by controlling pulse emission (e.g., light emission) from its display pixels based on pixel or image data associated with corresponding image pixels (e.g., points) in the image. In some embodiments, pixel or image data may be generated by an image source (e.g., image data, digital code), such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display an image frame of content based on pixel or image data generated by the processor core complex 18, or the electronic display 12 may display frames based on pixel or image data received via the network interface 24, an input device, or an I/O port 16.

The eye tracker 28 may measure positions and movement of one or both eyes of someone viewing the electronic display 12 of the electronic device 10. For instance, the eye tracker 28 may include a camera that can record the movement of a viewer's eyes as the viewer looks at the electronic display 12. However, several different practices may be employed to track a viewer's eye movements. For example, different types of infrared/near infrared eye tracking techniques such as bright-pupil tracking and dark-pupil tracking may be used. In both of these types of eye tracking, infrared or near infrared light is reflected off of one or both of the eyes of the viewer to create corneal reflections. A vector between the center of the pupil of the eye and the corneal reflections may be used to determine a point on the electronic display 12 at which the viewer is looking. The processor core complex 18 may use the gaze angle(s) of the eyes of the viewer when generating image data for display on the electronic display 12.

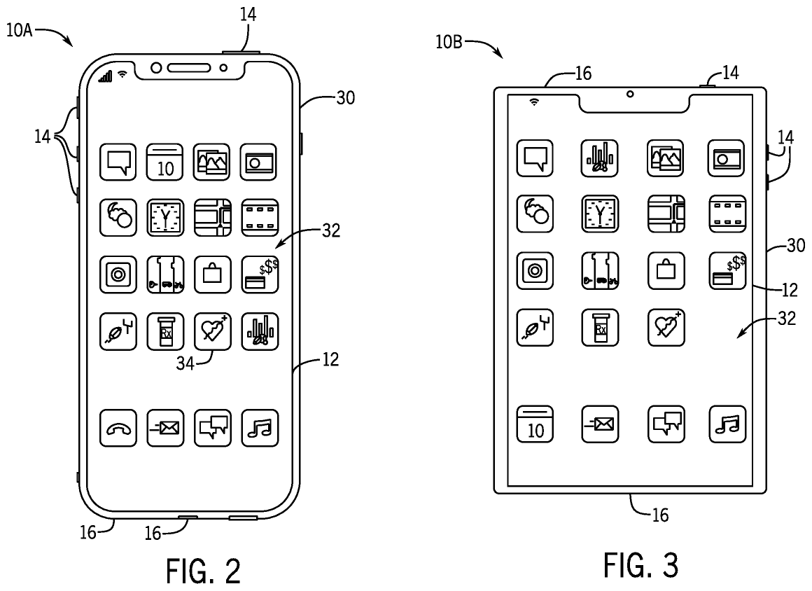

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as any IPHONE® model available from Apple Inc.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

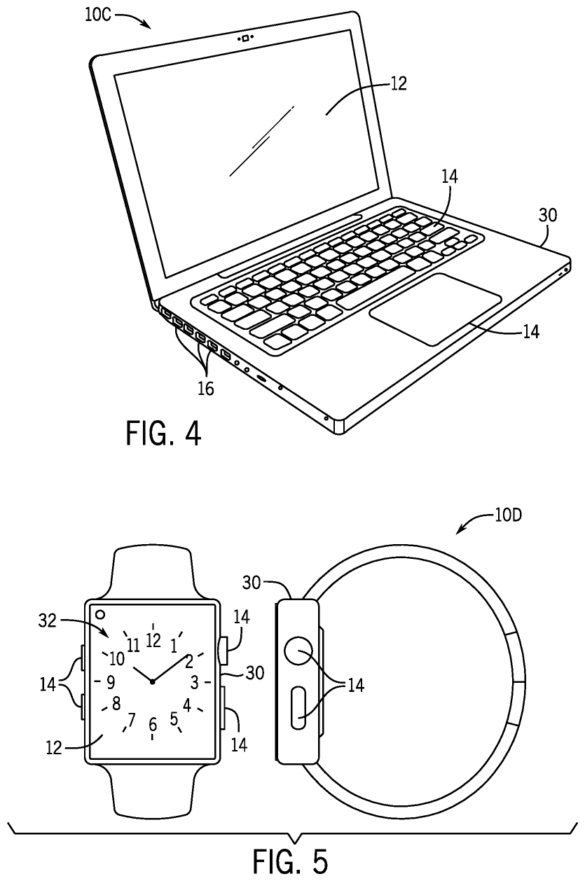

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

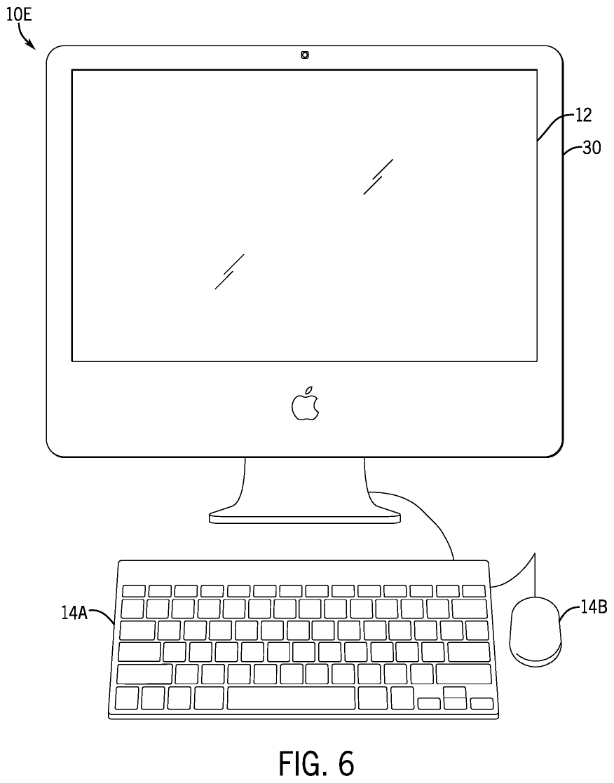

Turning to FIG. 6, a computer 10E may represent another embodiment of the electronic device 10 of FIG. 1. The computer 10E may be any computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 30 may be provided to protect and enclose internal components of the computer 10E, such as the display 12. In certain embodiments, a user of the computer 10E may interact with the computer 10E using various peripheral input structures 14, such as the keyboard 14A or mouse 14B (e.g., input structures 14), which may connect to the computer 10E.

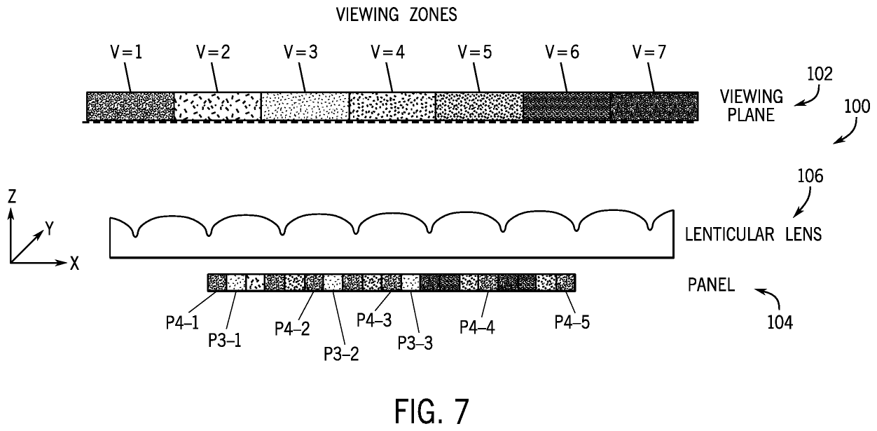

FIG. 7 is a schematic diagram illustrating a portion of a cross section of a multidimensional electronic display 12 and one viewing plane 102. In the embodiment illustrated in FIG. 7, the multidimensional electronic display 12 may include a display panel 104 and a lenticular lens layer 106. As illustrated in FIG. 7, the normal vector of the display panel 104 is shown along the Z-axis, and the display panel 104 is in X-Y plane. The display panel 104 may include display pixels (also referred to as subpixels) for displaying images, and each display pixel may correspond to a pair of XY coordinates in the X-Y plane. The lenticular lens layer 106 may be used to create parallax (e.g., horizontally (e.g., along X axis) or vertically (e.g., along Y axis), or both) for viewing zones, also referred to herein as “views,” (e.g., V=1, 2, 3, 4, 5, 6, 7) on the viewing plane 102 so that a respective group of pixels (or sub pixels) on the display panel 104 may only be seen in the corresponding viewing zone. For example, pixels P4-1, P4-2, P4-3, P4-4, and P4-5 may only be seen in the viewing zone V=4, and pixels P3-1, P3-2, and P3-3 may only be seen in the viewing zone V=3. The viewing zones may correspond to viewing angles of a 3D object in images displaying on the display panel 104. Accordingly, different camera viewpoints or object poses of the 3D object may be seen in different viewing zones on the viewing plane 102, thereby generating 3D scene representations. A view map may define which display pixels correspond to which view zones (“views”). Although, in the example illustrated in FIG. 7, the view zones (e.g., V=1, 2, 3, 4, 5, 6, 7) may be along the horizontal direction (e.g., along X axis), the view zones may also be along the vertical direction (e.g., along Y axis) when the lenticular lens layer 106 is used to create parallax vertically (e.g., along Y axis). In addition, although discrete view zones are illustrated in FIG. 7, views may be continuous as the viewing angles may be continuously distributing in the 3D space. Accordingly, a view map may include discrete or continuous viewing angles of a 3D object.

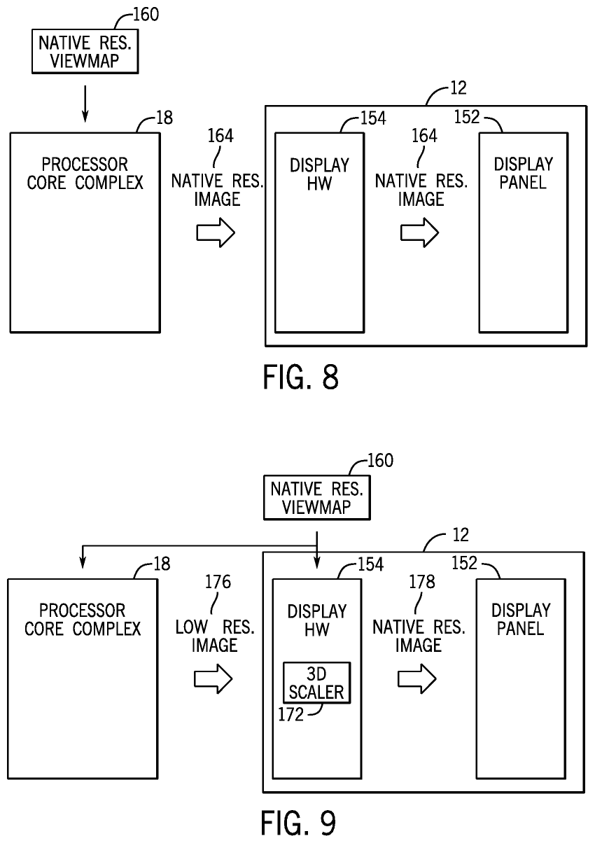

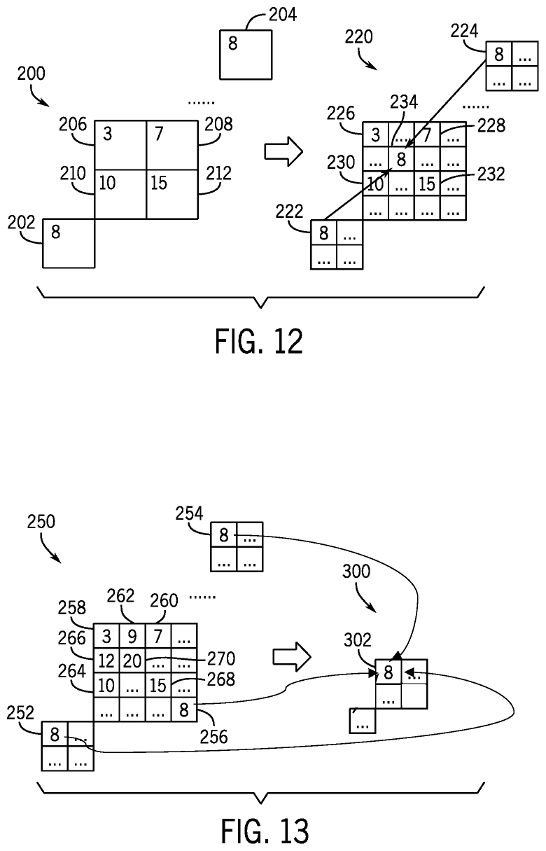

FIGS. 8-11 illustrate various examples of data flow between the processor core complex 18 and the electronic display 12 for images to be displayed on a display panel 152 of the electronic display 12. The electronic display 12 may include display hardware (HW) 154 (e.g., a timing controller (TCON), display driver integrated circuit (DDIC)) to control the images to be displayed on the display panel 152. FIG. 8 is a block diagram showing an example of data flow between the processor core complex 18 and the electronic display 12 the processor core complex generates image data in the native resolution of the electronic display 12. A native resolution view map 160 may be defined based on the native resolution of the display panel 152 and/or a viewer gaze position detected by the eye tracker 28. Examples of view maps are provided with reference to FIGS. 12-16 and will be discussed further below. Continuing to view FIG. 8, the processor core complex 18 may use the native-resolution view map 160 to generate a native resolution 3D-aware image 164. When provided to the electronic display 12, the display hardware 154 may avoid scaling the image data of the 3D-aware image 164 since it is already in the native resolution of the electronic display 12. The native resolution 3D-aware image 164 may then be programmed into the display panel 152 from the display HW 154.

To scale and/or enhance the image data to improve perceived quality of an image, a multidimensional scaler block, such as a 3D scaler block, may be used in the display hardware 154. Although, in the example illustrated in FIGS. 9-11, the 3D scaler 172 is located inside the display 12, the 3D scaler 172 may also be located inside the processor core complex 18. FIG. 9 is a block diagram showing an example data flow between the processor core complex 18 and the electronic display 12 that uses a 3D scaler block 172 to scale up low-resolution image data. The native-resolution view map 160 may be stored in or loaded into the display HW 154. The native-resolution view map 160 may be defined based on the native resolution of the display panel 152 and/or a viewer gaze position detected by the eye tracker 28. Examples of view maps are provided with reference to FIGS. 12-16 and will be discussed further below. Continuing to view FIG. 9, the native-resolution view map 160 or a lower-resolution version of the view map 160 may also be stored in or loaded into the processor core complex 18. The processor core complex 18 may generate a low-resolution (e.g., lower than the native resolution) 3D-aware image 176 according to the view map 160 or the lower-resolution version of the view map 160. The low-resolution 3D-aware image 176 may be transmitted to the display HW 154, and the 3D scaler 172 may use the native-resolution view map 160 to up-sample the low-resolution 3D-aware image 176 to a native-resolution 3D-aware image 178 (an example of which is illustrated in FIG. 12 and discussed in greater detail below). The native-resolution 3D-aware image 178 may be programmed onto the display panel 152. Accordingly, in the example of FIG. 9, low-resolution images may be received by the processor core complex 18 and used in image data processing, which may save power, reduce data load, and use less computation resources.

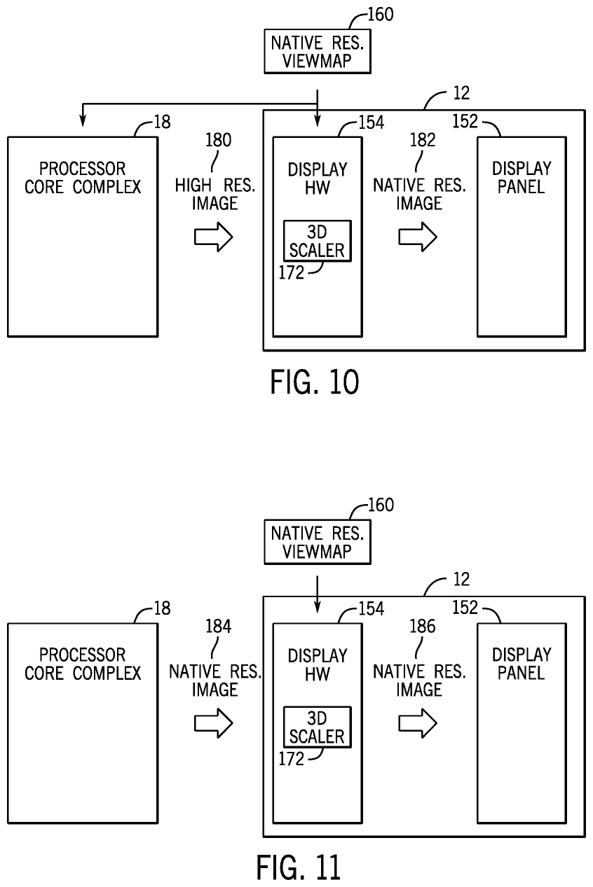

FIG. 10 is a block diagram showing another example of data flow between the processor core complex 18 and the electronic display 12, which uses a 3D scaler block 172 to scale down high-resolution image data. In this example, the native-resolution view map 160 may be stored in or loaded into the display HW 154. The native-resolution view map 160 may be defined based on the native resolution of the display panel 152 and/or a viewer gaze position detected by the eye tracker 28. Examples of view maps are provided with reference to FIGS. 12-16 and will be discussed further below. Continuing to view FIG. 10, the native-resolution view map 160 or a higher-resolution version of the view map 160 may also be stored in or loaded into the processor core complex 18. The processor core complex 18 may generate a high-resolution (e.g., any suitable resolution higher than the native resolution) 3D-aware image 180 using the view map 160 or higher-resolution version of the view map 160. The high-resolution 3D-aware image 180 may be transmitted to the display HW 154, and the 3D scaler 172 may use the native-resolution view map 160 to down-sample the high resolution 3D-aware image 180 to a native resolution 3D-aware image 182 (an example of which is illustrated in FIG. 13). The native resolution 3D-aware image 182 may be programmed into the display panel 152. Accordingly, in the embodiment illustrated in FIG. 10, high-resolution (e.g., higher than the native resolution) images may be received by the processor core complex 18 and used for image data processing, which may achieve better image quality, such as anti-aliasing, better smoothness, or the like.

FIG. 11 is a block diagram showing another example of data flow between the processor core complex 18 and the electronic display 12. The native-resolution view map 160 may be stored or loaded into the display HW 154. The native-resolution view map 160 may be defined based on the native resolution of the display panel 152 and/or a viewer gaze position detected by the eye tracker 28. Examples of view maps are provided with reference to FIGS. 12-16 and will be discussed further below. Continuing to view FIG. 11, the processor core complex 18 may generate a native resolution 3D-aware image 184, which may be generated using a view map formatting different from the native resolution view map 160, may be received by the processor core complex 18. For example, the processor core complex 18 may perform rendering that may or may not follow the same format or order as the native resolution of the display panel 152. Indeed, the rendering may be done in a rectangular or other suitable graphics processing unit (GPU)-friendly (e.g., power or computationally efficient) format or order. The view map information of the native-resolution view map 160 may not even be used by the processor core complex 18.

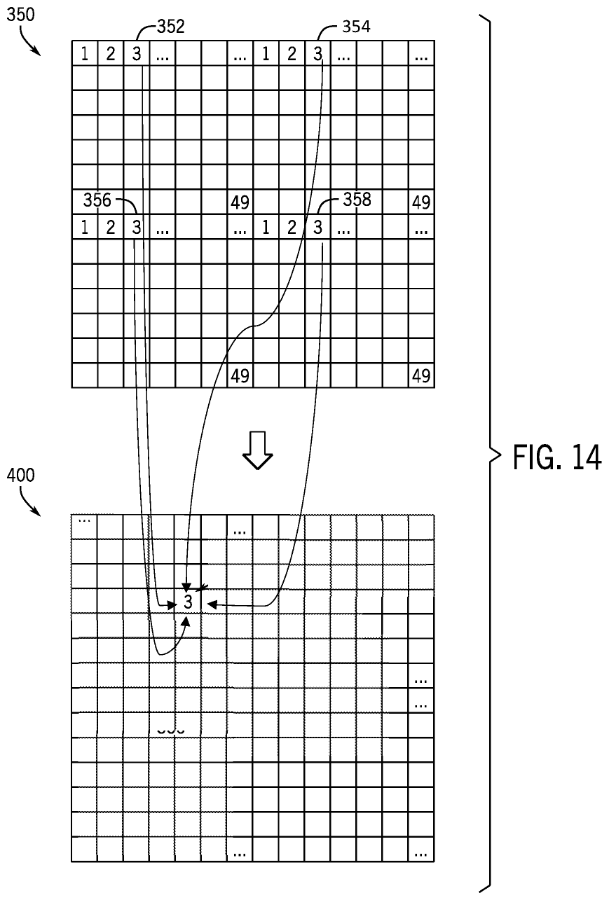

The native resolution 3D-aware image 184 may be transmitted to the display HW 154 and the 3D scaler 172 may use the native resolution view map 160 to convert the native resolution 3D-aware image 184 to a view map guided native resolution 3D-aware image 186, which uses the view map formatting of the native resolution view map 160 (e.g., as illustrated in FIG. 14 and discussed in greater further below). The view map guided native resolution 3D-aware image 186 may be programmed into the display panel 152. Accordingly, in the example illustrated in FIG. 11, native resolution images with different view map formatting may be received by the processor core complex 18 and used for image data processing, which may achieve better processing effect and/or be more efficient.

FIG. 12 is a block diagram illustrating image data scaling from low resolution to high resolution. FIG. 12 shows a portion 200 of a low-resolution 3D-aware image (e.g., the low resolution image 176) having multiple view zones. Since the parallax on viewing planes may be generated horizontally (e.g., along X axis) and/or vertically (along Y axis), view zones may also be along the vertical direction (e.g., along Y axis). Accordingly, in the portion 200, multiple pixels (or subpixels) located in multiple rows and columns may correspond to a same view zone. For example, pixels (or subpixels) 202 and 204 may correspond to view zone 8 of the multidimensional electronic display panel, a pixel (or subpixel) 206 may correspond to view zone 3, a pixel 208 (or subpixel) may correspond to view zone 7, a pixel 210 (or subpixel) may correspond to view zone 10, and a pixel 212 (or subpixel) may correspond to view zone 15. During the scaling process in the 3D scaler 172 in the display HW 154, the portion 200 with lower resolution may be scaled to a portion 220 with a higher resolution by interpolating new pixel values. Accordingly, additional pixel values may be interpolated for one or more pixels (or subpixels) in a view zone in the portion 220. For example, the portion 220 may include pixels 222, 224, and 234 corresponding to view zone 8 of the multidimensional electronic display panel, a pixel 226 corresponding to view zone 3, a pixel 228 corresponding to view zone 7, a pixel 230 corresponding to view zone 10, a pixel 232 corresponding to view zone 15. Corresponding pixel location and pixel value for the additional pixel 234 in view zone 8 may be determined based on the pixels in the view zone 8 in the portion 220, such as pixels 222 and 224, which correspond to pixels (or subpixels) 202 and 204 in the portion 200, respectively. In the case that the portion 200 is generated based on a lower-resolution (e.g., lower than the native resolution) version of the view map 160 and the portion 220 is generated based on a higher-resolution (e.g., the native resolution) version of the view map 160, the pixels (or subpixels) on the multidimensional electronic display panel corresponding to a view zone in the portion 200 may correspond to two or more view zones in the portion 220. For example, the pixels (or subpixels) on the multidimensional electronic display panel corresponding to view zone 3 in the portion 200 may correspond to view zone 3 (e.g., pixel 226) and view zone 8 (e.g., pixel 234) in the portion 220.

FIG. 13 is a block diagram illustrating image data scaling from high resolution to low resolution. FIG. 13 shows a portion 250 of a higher-resolution (e.g., higher than the native resolution) 3D-aware image having multiple view zones, which may be scaled to a portion 300 of a lower resolution by pixel grouping. For instance, in the portion 250, pixels 252, 254, and 256 may correspond to view zone 8 of the multidimensional electronic display panel 152, a pixel 258 may correspond to view zone 3, a pixel 260 may correspond to view zone 7, a pixel 262 may correspond to view zone 9, a pixel 264 may correspond to view zone 10, a pixel 266 may correspond to view zone 12, a pixel 268 may correspond to view zone 15, and a pixel 270 may correspond to view zone 20. During the scaling down process in the 3D scaler 172 in the display HW 154, the portion 250 having the higher resolution may be scaled to the portion 300 having the lower resolution (e.g., the native resolution) by pixel grouping. For example, the pixel value for a pixel (or subpixel) 302 corresponding to view zone 8 in the portion 300 may be determined based on the pixels corresponding to the view zone 8 in the portion 250, such as the pixels 252, 254, and 256. In the case that the portion 300 is generated based on a lower-resolution (e.g., lower than the native resolution) version of the view map 160 and the portion 250 is generated based on a higher-resolution (e.g., the native resolution) version of the view map 160, the pixels (or subpixels) on the multidimensional electronic display panel corresponding to a view zone in the portion 300 may correspond to two or more view zones in the portion 250.

FIG. 14 is a block diagram illustrating image data converting between different view map formatting. In FIG. 14, a native resolution 3D-aware image 350 may be labeled using a rectangular view map having multiple viewing zones (e.g., using a matrix for each group of multiple viewing zones). The rectangular view map labeled 3D-aware image may be processed in the Graphic Processing Unit (GPU), however, it may not reflect actual pixel directionality on the display panel 152. For example, pixels (or subpixels) 352, 354, 356, and 358 may correspond to view zone 3 of the display panel 152 but may not be organized in the 3D-aware image 350 to map to the pixels coordinates on the display panel 152 and thus may not reflect actual pixel directionality on the display panel 152. The 3D-aware image 350 may be converted to a 3D-aware image 400 labeled using a view map for the display panel 152. For example, the image data in the 3D-aware image 350 may be resampled so that pixels (or subpixels) may be organized in the 3D-aware image 400 mapping to the pixels coordinates on the display panel 152. For example, the pixel value for a pixel 402 corresponding to view zone 3 in the 3D-aware image 400 may be determined based on the pixels corresponding to the view zone 3 in the 3D-aware image 350, such as the pixels 352, 354, and 356.

Accordingly, pixel values for pixels in a view zone may be determined by utilizing a per-view zone 3D-aware image for the view zone. A per-view zone 3D-aware image may only include pixels in one view zone. Various image processing methods (e.g., methods used in processing two dimensional images) may be used to process the per-view zone 3D-aware image for the view zone. In addition, other method may also be used for scaling image from one resolution to another resolution, such as iterative approach, machine learning super-resolution method, etc. A high-resolution/low-resolution 3D-aware image may be generated from a low-resolution/high-resolution 3D-aware image by including a respective per-view zone 3D-aware image with high-resolution/low-resolution for each view zone.

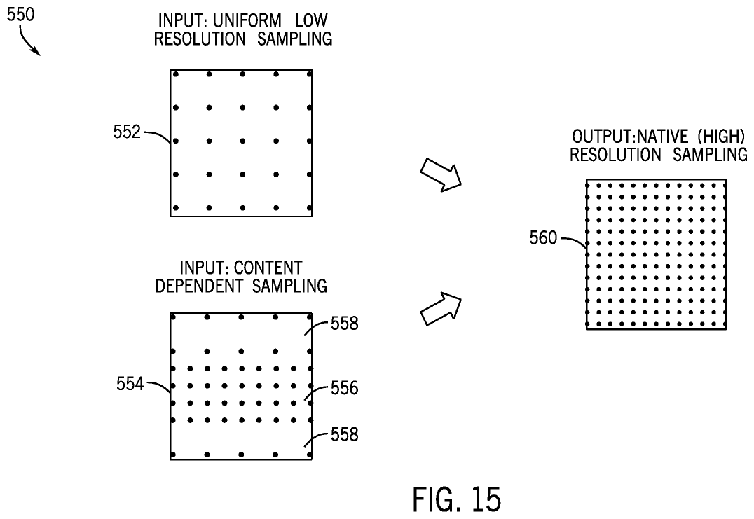

FIG. 15 depicts a flow diagram of a process 550 for content-dependent sampling (e.g., used in super-sampling) in the 3D scaler. As discussed above, an image with a uniform low-resolution may be received by the processor core complex 18 and used in image data processing, which may save power, reduce data load, and use less computation resources, and the image may be restored to a higher resolution before being displayed by utilizing the per-view zone 3D-aware image. In addition, the method described above may also be used for images with non-uniform low-resolution, as described in details herein. For instance, the 3D scaler 172 may receive a 3D-aware image 552 with a uniform low resolution (e.g., lower than the native resolution of the display panel). The 3D scaler 172 may also receive a 3D-aware image 554, which may have non-uniform image resolution with more samples (high resolution) applied to a region-of-interest (e.g., foveation content with more details) area 556 and less samples (low resolution) applied to other area 558. The location and size of the area 556 may be determined based on a region-of-interest in content of the 3D-aware image 552 (e.g., a viewer gaze position detected by the eye tracker 28). As described above, a respective per-view zone 3D-aware image with higher resolution in a certain view zone may be obtained for the 3D-aware images 552 and 554. Accordingly, a respective final 3D-aware image 560 with higher resolution for all view zones may be obtained for the images 552 and 554 by including a respective per-view zone 3D-aware image for each view zone. Since the 3D-aware image 554 includes more samples (high resolution) applied to the region-of-interest (e.g., foveation content with more details) area 556, the corresponding final 3D-aware image 560 generated using the image 554 may have higher quality at the area 556 than the corresponding final 3D-aware image 560 generated using the image 552.

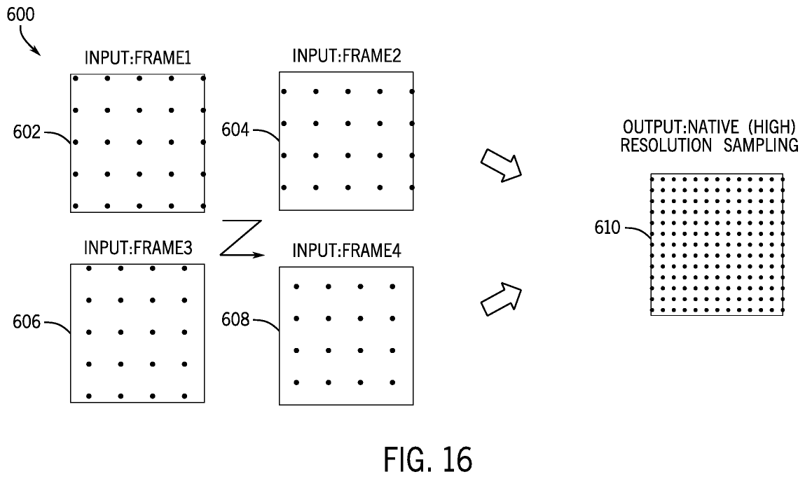

FIG. 16 depicts a flow diagram of a process 600 for temporal sampling (e.g., used in super-sampling) in the 3D scaler 172. For instance, the 3D scaler 172 may receive multiple 3D-aware images taken at different time in a time period. For example, 3D-aware images 602, 604, 606, and 608 may be taken at different time (e.g., sequentially), as illustrated in FIG. 16. The 3D-aware images 602, 604, 606, and 608 may have the same low resolution (e.g., lower than the native resolution) but different sampling locations. Accordingly, pixel values may be provided at different locations in the 3D-aware images 602, 604, 606, and 608. As described above, a respective per-view zone 3D-aware image with higher resolution (e.g., native resolution) in a certain view zone may be obtained for each of the 3D-aware images 602, 604, 606, and 608. A respective final 3D-aware image 610 with the higher resolution (e.g., native resolution) may be obtained for the images 602, 604, 606, and 608 by including a respective per-view zone 3D-aware image for each view zone. The final 3D-aware images 610 with the higher resolution (e.g., native resolution) for the images 602, 604, 606, and 608 may be displayed at corresponding time (e.g., sequentially) to obtain averaging better image quality.

Accordingly, the method described above may be used for image processing of 3D-aware images with multiple view zones. Each view zone of the 3D-aware images may be processed individually to obtain a respective processed per-view zone 3D-aware image, and the final processed 3D-aware image may include the processed per-view zone 3D-aware images for all view zones.

The specific embodiments described above have been shown by way of example, and it should be understood that these embodiments may be susceptible to various modifications and alternative forms. It should be noted that, although LEDs and LED drivers are used in the embodiments described above, other illuminators and their drivers may use the techniques presented above. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An electronic device, comprising:
an electronic display configured to display a multiple-viewing-angle image; and
a scaler configured to change a formatting of the multiple-viewing-angle image for displaying on the electronic display.

2. The electronic device of claim 1, wherein the multiple-viewing-angle image comprises image data in a plurality of view zones of the electronic display.

3. The electronic device of claim 2, wherein the plurality of view zones of the electronic display comprises a horizontal view zone, a vertical view zone, or both.

4. The electronic device of claim 2, wherein each of the plurality of view zones indicates a respective pixel directionality of the electronic display.

5. The electronic device of claim 4, wherein a view map is used to define the pixel directionalities of the plurality of view zones, and the multiple-viewing-angle image is labeled by using the view map.

6. The electronic device of claim 5, wherein the formatting comprises a view map formatting used to define view zones of pixels of the multiple-viewing-angle image.

7. The electronic device of claim 5, wherein the scaler is configured to resample the multiple-viewing-angle image based on the view map to generate a respective per-view zone multiple-viewing-angle image for each view zone of the plurality of view zones.

8. The electronic device of claim 1, wherein the formatting comprises a resolution.

9. The electronic device of claim 1, wherein the scaler is in a processing unit of the electronic device.

10. The electronic device of claim 1, wherein the scaler is in the electronic display.

11. An electronic device, comprising:
an electronic display configured to display a 3D-aware image using a native resolution;
processing circuitry configured to receive the 3D-aware image using a certain resolution different from the native resolution; and
a scaler in the electronic device configured to change the certain resolution of the 3D-aware image to the native resolution for displaying the 3D-aware image on the electronic display.

12. The electronic device of claim 11, wherein the certain resolution is lower than the native resolution.

13. The electronic device of claim 11, wherein the certain resolution is higher than the native resolution.

14. The electronic device of claim 11, wherein a view map is used to define pixel directionalities of a plurality of view zones of the electronic display, and the 3D-aware image is labeled by using the view map, wherein the plurality of view zones of the electronic display comprises a horizontal view zone, a vertical view zone, or both.

15. The electronic device of claim 11, wherein the scaler is in the electronic display or the processing circuitry.

16. A method comprising:
receiving, via a scaler of an electronic display, a first portion of a 3D-aware image having a first resolution including a first set of image data for a plurality of view zones of the electronic display; and
generating, via the scaler, a first respective per-view zone 3D-aware image having a certain resolution for each view zone of the plurality of view zones for the first portion of the 3D-aware image.

17. The method of claim 16, comprising:
receiving, via the scaler, a second portion of the 3D-aware image having a second resolution including a second set of image data for the plurality of view zones of the electronic display; and
generating, via the scaler, a second respective per-view zone 3D-aware image having the certain resolution for each view zone of the plurality of view zones for the second portion of the 3D-aware image.

18. The method of claim 17, comprising:
generating, via the scaler, a respective per-view zone 3D-aware image having the certain resolution for each view zone of the plurality of view zones by including the first respective per-view zone 3D-aware image and the second respective per-view zone 3D-aware image; and
displaying the respective per-view zone 3D-aware image for each view zone of the plurality of view zones on the electronic display.

19. The method of claim 17, wherein the first portion of the 3D-aware image is generated by using a first sampling at a first time and the second portion of the 3D-aware image is generated by using a second sampling at a second time.

20. The method of claim 19, wherein the first respective per-view zone 3D-aware image and the second respective per-view zone 3D-aware image are displayed on the electronic display at different times.
